(19) United States
(12) Patent Application Publication
(10) Pub. No.: US 2025/0047805 A1
(43) Pub. Date: Feb. 6, 2025

(54) MOBILE VIDEO COLLABORATION AND STREAMING PLATFORM

(71) Applicant: QUATRA LLC, Murrieta, CA (US)

(72) Inventors: Paul Guth, Murrieta, CA (US); Matthew Guth, Murrieta, CA (US)

(21) Appl. No.: 18/795,135

(22) Filed: Aug. 5, 2024

Related U.S. Application Data
(60) Provisional application No. 63/530,598, filed on Aug. 3, 2023.

(51) Int. Cl. H04N 5/77; H04W 4/029

(52) U.S. Cl. CPC H04N 5/77; H04W 4/029

(57) ABSTRACT

An apparatus includes a mobile cart, a device mount that adjusts an orientation of devices attached to the device mount, and a user interface communicatively coupled to the devices. In another aspect, a system includes a mobile cart, a device mount coupled to the mobile cart, and a remote tracking device communicatively coupled to the mobile cart or the device mount. The device mount adjusts an orientation of devices attached to the device mount, whereas the remote tracking device is coupled to a subject to facilitate a physical tracking of the subject. In a further aspect, a method includes physically coupling a remote tracking device to a subject and communicatively coupling the remote tracking device to a mobile cart or a device mount coupled to the mobile cart. The remote tracking device is then physically tracked by the mobile cart or the device mount.

### CROSS-REFERENCE TO RELATED APPLICATIONS

This application claims the benefit of U.S. Provisional Patent Application Ser. No. 63/530,598, filed Aug. 3, 2024, which is titled “MOBILE VIDEO COLLABORATION AND STREAMING PLATFORM” and its entire contents of which are incorporated herein by reference.

### TECHNICAL FIELD

The subject disclosure generally relates to aspects that facilitate video production, and more specifically to an apparatus and methodology that facilitates mobile video collaboration and streaming.

### BACKGROUND

By way of background concerning conventional video production and collaboration, it is noted that the management and positioning of multiple devices (e.g., multiple cameras, microphones, lights, etc.) is difficult and restrictive to mobile and dynamic movement, which hinders the production of mobile free-flowing or natural collaboration and/or content. Moreover, conventional video collaboration is generally restricted to a desktop, conference room, or mobile device which hinders natural dynamic communication. This becomes especially true when video collaboration or streaming video content is dealing with a physical and/or technical subject that is best served with multiple camera angles and mobility to fully capture details for more effective communication. Also, for solo producers, managing various aspects of production while presenting may be difficult (e.g., camera positioning, audio management, and video feed control).

Accordingly, it would be desirable to provide an apparatus and methodology which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with facilitating mobile video collaboration and streaming. In one such aspect, a mobile studio apparatus is provided, which includes a mobile cart and at least one device mount coupled to the mobile cart. Within such embodiment, the at least one device mount is configured to attach to a device, and further configured to adjust an orientation of the device. The mobile studio apparatus also includes a user interface communicatively coupled to devices configured to attach to the at least one device mount. Here, the user interface is configured to facilitate a video production or video collaboration via the devices configured to attach to the at least one device mount.

In a further aspect, a mobile studio system is provided, which includes at least one mobile cart, at least one device mount coupled to the at least one mobile cart, and at least one remote tracking device communicatively coupled to at least one of the at least one mobile cart or the at least one device mount. Within such embodiment, the at least one device mount is configured to attach to a device, and further configured to adjust an orientation of the device. Also, for this embodiment, the at least one remote tracking device is physically coupled to a subject and configured to facilitate a physical tracking of the subject by at least one of the at least one mobile cart or the at least one device mount.

In yet another aspect, a method is provided, which includes physically coupling at least one remote tracking device to a subject and communicatively coupling the at least one remote tracking device to at least one of at least one mobile cart or at least one device mount coupled to the at least one mobile cart. The method further includes configuring the at least one remote tracking device to be physically tracked by at least one of the at least one mobile cart or the at least one device mount. Here, a physical tracking of the at least one remote tracking device by the at least one mobile cart includes following a path of the subject, whereas a physical tracking of the at least one remote tracking device by the at least one device mount includes adjusting an orientation of the at least one device mount towards the subject.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 is a block diagram illustrating an exemplary mobile studio apparatus in accordance with an aspect of the subject specification;

FIG. 2 illustrates an exemplary environment that facilitates mobile video collaboration and streaming in accordance with an aspect of the subject specification;

FIG. 3 is a photo illustrating a first view of an exemplary mobile studio apparatus in accordance with an aspect of the subject specification;

FIG. 4 is a photo illustrating a second view of an exemplary mobile studio apparatus in accordance with an aspect of the subject specification;

FIG. 5 is a photo illustrating a rear view of an exemplary mobile studio apparatus where the display arm is in an unbent position in accordance with an aspect of the subject specification;

FIG. 6 is a photo illustrating a rear view of an exemplary mobile studio apparatus where the display arm is in a bent position in accordance with an aspect of the subject specification;

FIG. 7 is a photo illustrating an exemplary mobile studio apparatus where the display arm is in an extended position in accordance with an aspect of the subject specification;

FIG. 8 is a photo illustrating an exemplary mobile studio apparatus where the display arm is in an unextended position in accordance with an aspect of the subject specification;

FIG. 9 is a photo illustrating an exemplary mobile studio apparatus where a detachable camera is attached in accordance with an aspect of the subject specification;

FIG. 10 is a photo illustrating an exemplary mobile studio apparatus where a detachable camera is detached in accordance with an aspect of the subject specification;

FIG. 11 illustrates a block diagram of an exemplary mobile studio system that facilitates implementing aspects disclosed herein;

FIG. 12 is a flow diagram of an exemplary methodology that facilitates aspects disclosed herein;

FIG. 13 is a block diagram representing exemplary non-limiting networked environments in which various embodiments described herein can be implemented; and

FIG. 14 is a block diagram representing an exemplary non-limiting computing system or operating environment in which one or more aspects of various embodiments described herein can be implemented.

### DETAILED DESCRIPTION

### Overview

As discussed in the background, conventional video production and collaboration techniques have several undesirable limitations. Various aspects disclosed herein are directed towards overcoming such limitations by providing a wireless mobile video collaboration and video streaming platform configured as a cart with multiple camera mounting and deployment options. For instance, in a particular aspect, a cart is equipped with a monitor or display showing video collaboration attendees and/or a live video feed, wherein users of the cart have various display mounting options and may easily switch between multiple quick-release cameras, microphones, and/or lights to facilitate a mobile free-flowing natural video communication for video collaboration or video streaming.

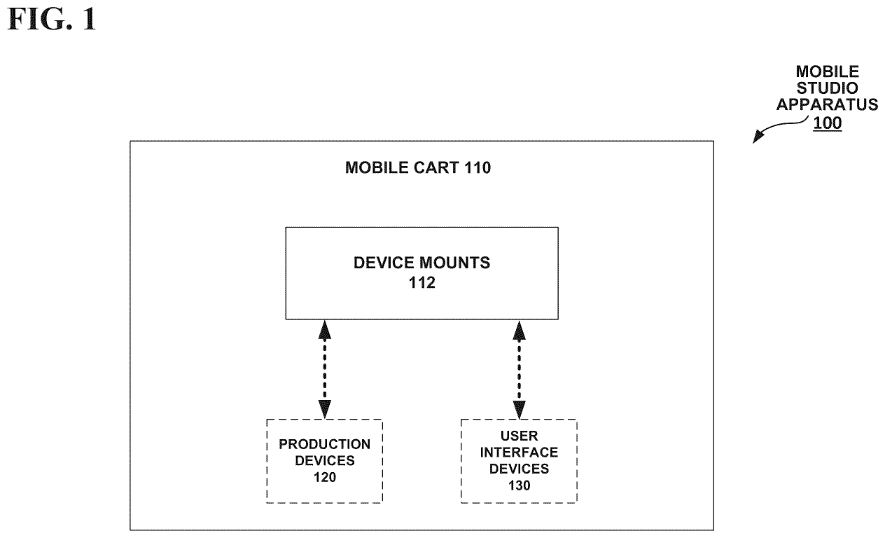

Referring next to FIG. 1, a block diagram is provided illustrating an exemplary mobile studio apparatus in accordance with an aspect of the subject specification. As illustrated, it is contemplated that a mobile studio apparatus 100 may comprise a mobile cart 110 and at least one device mount 112 coupled to the mobile cart 110, wherein the at least one device mount 112 is configured to attach to a device (e.g., production devices 120 and/or user interface devices 130), and further configured to adjust an orientation of the device (e.g., via a pivot point, an adjustable/extendible arm, etc.). For this embodiment, mobile studio apparatus 100 may also comprise a user interface communicatively coupled to devices configured to attach to the at least one device mount 112, wherein the user interface is configured to facilitate a video production or video collaboration via the devices configured to attach to the at least one device mount 112.

In a particular aspect disclosed herein, it is contemplated that any of various types of devices may be coupled to mobile cart 110 via any of a plurality of different types of device mounts 112. For instance, a first subset of the plurality of device mounts 112 may be configured to attach to production devices 120 (e.g., cameras, microphones, lights, etc.), whereas a second subset of the plurality of device mounts 112 may be configured to attach to user interface devices (e.g., a display, mobile phone, laptop, etc.). It is also contemplated that the at least one device mount 112 may comprise a quick-release mechanism configured to facilitate readily attaching and detaching a device, wherein the device remains functional when detached from the at least one device mount (e.g., via a wireless protocol).

### Exemplary Communication Environment

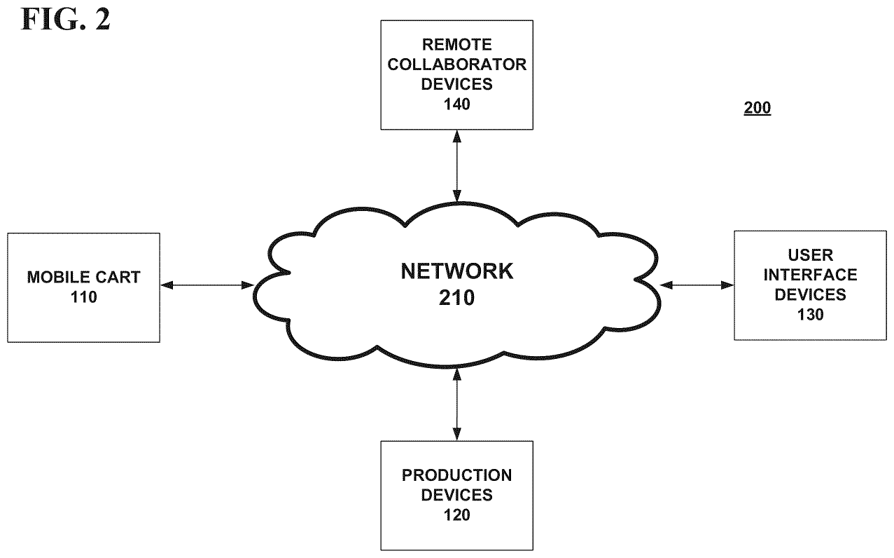

As previously mentioned, it is contemplated that mobile studio apparatus 100 may comprise a user interface to facilitate video production or video collaboration. Referring next to FIG. 2, an exemplary environment is provided that facilitates mobile video collaboration and streaming via such user interface in accordance with an aspect of the subject specification. As illustrated, environment 200 includes mobile cart 110, production devices 120, user interface devices 130, and remote collaborator devices 140, which are communicatively coupled to each other via a network 210 (e.g., the Internet).

Within such embodiment, it is contemplated that the user interface may be configured to control mobile cart 110 (e.g., control a movement of mobile cart 110) and/or production devices 120 (e.g., control an orientation of production devices 120) via user interface devices 130 and/or remote collaborator devices 140, wherein individual production devices 120 and individual user interface devices 130 may or may not be physically coupled to mobile studio apparatus 100. For instance, in a first exemplary use case, mobile cart 110 and/or production devices 120 are controlled via user interface devices 130 that are proximate to mobile studio apparatus 100 (e.g., via a laptop computer physically mounted onto mobile cart 110). Alternatively, a remote collaborator may control mobile cart 110 and/or production devices 120 via remote collaborator devices 140 directly (e.g., where a remote collaborator device 140 communicates directly with production devices 120) or indirectly (e.g., where a remote collaborator device 140 communicates indirectly with production devices 120 via user interface devices 130).

In another aspect disclosed herein, it is contemplated that environment 200 may facilitate automatically controlling mobile cart 110 and/or production devices 120 via the user interface. For instance, where the subject of a video is moving, mobile cart 110 may be configured to automatically follow the subject. Similarly, production devices 120 may comprise a plurality of cameras mounted on various pivot points/arms on mobile cart 110, wherein the pivot points/arms may be configured to automatically orient the cameras toward the subject as the subject moves.

It is also contemplated that a video production/collaboration showing multiple camera angles/views may be desirable. For instance, when evaluating a subject's golf swing, it may be desirable to observe such swing from different angles via differently positioned cameras. Within such a use case, a remote collaborator (e.g., a remotely located golf coach) may remotely control the positioning/orientation of the various cameras to obtain the desired angles. Alternatively, the remote collaborator may request that one or more cameras be detached from mobile cart 110 (e.g., via a quick-release mechanism) and placed elsewhere.

### Exemplary Embodiments

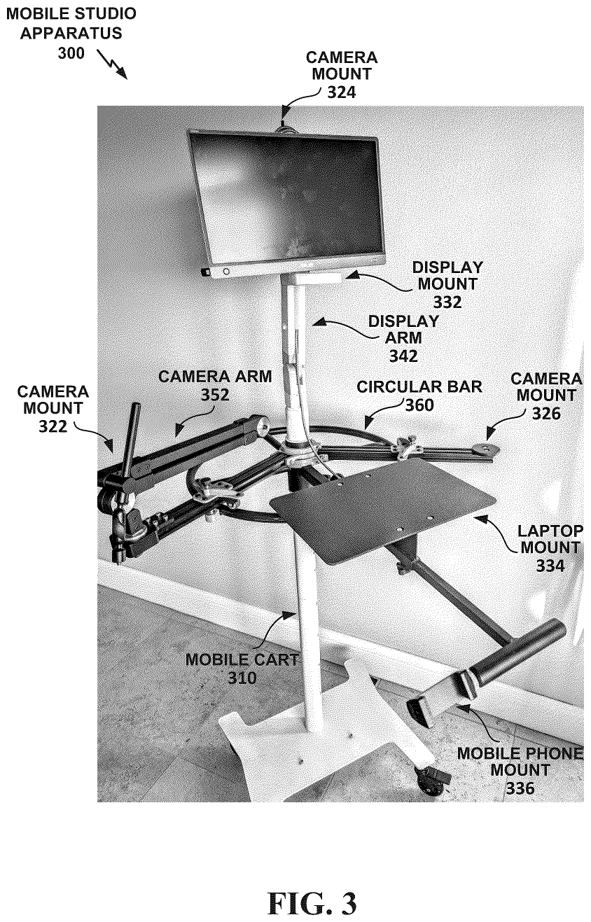

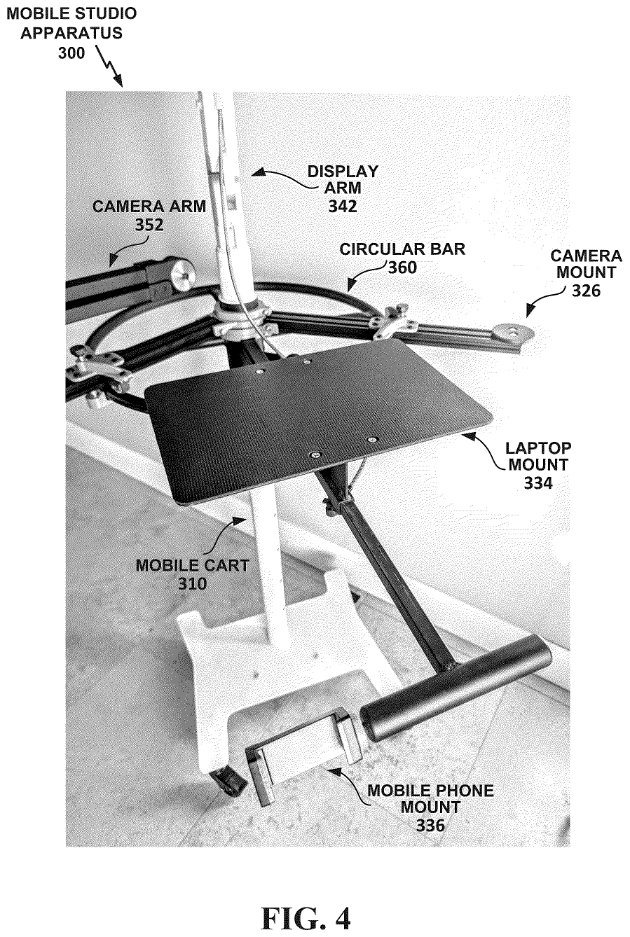

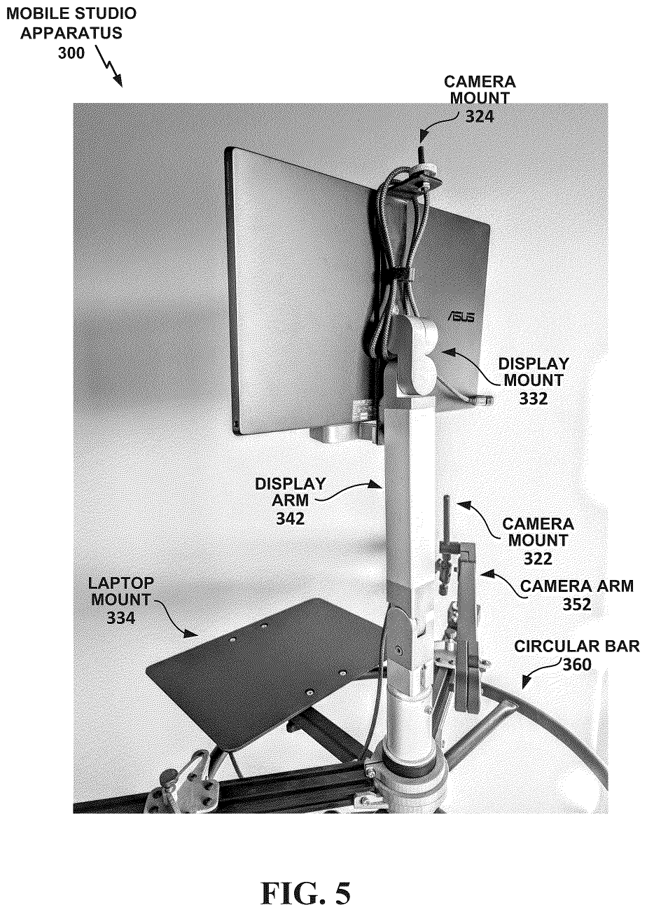

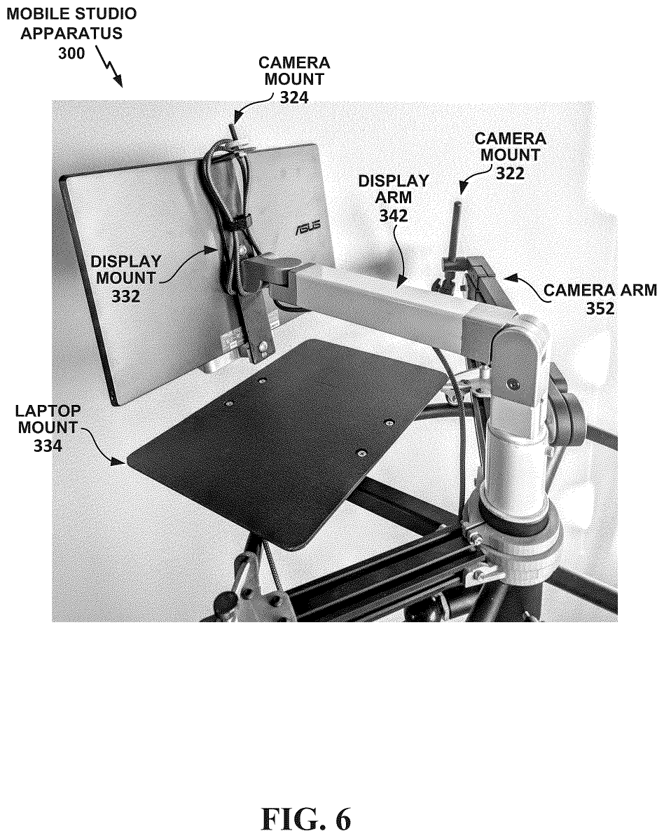

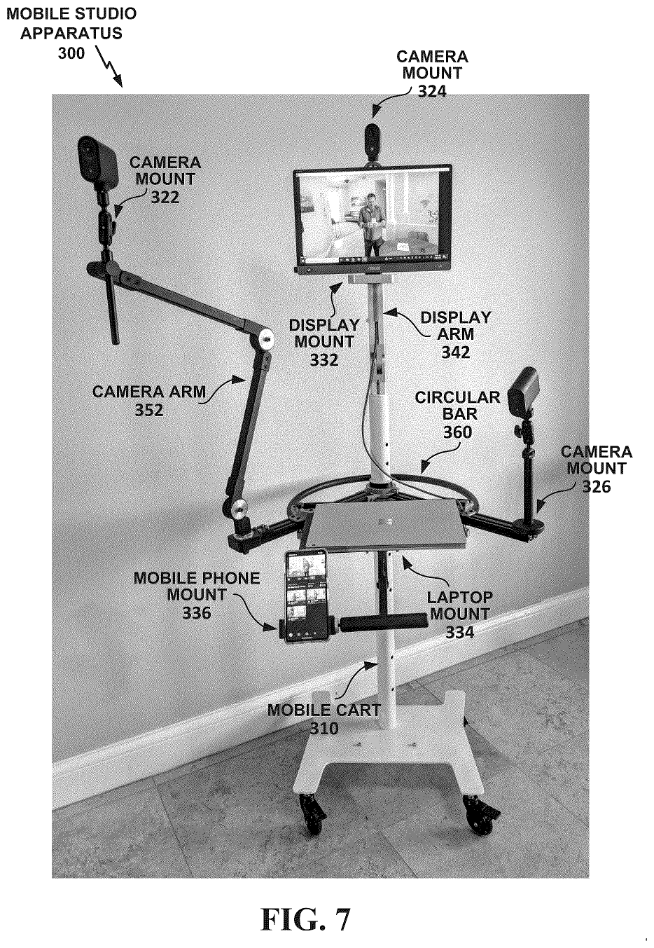

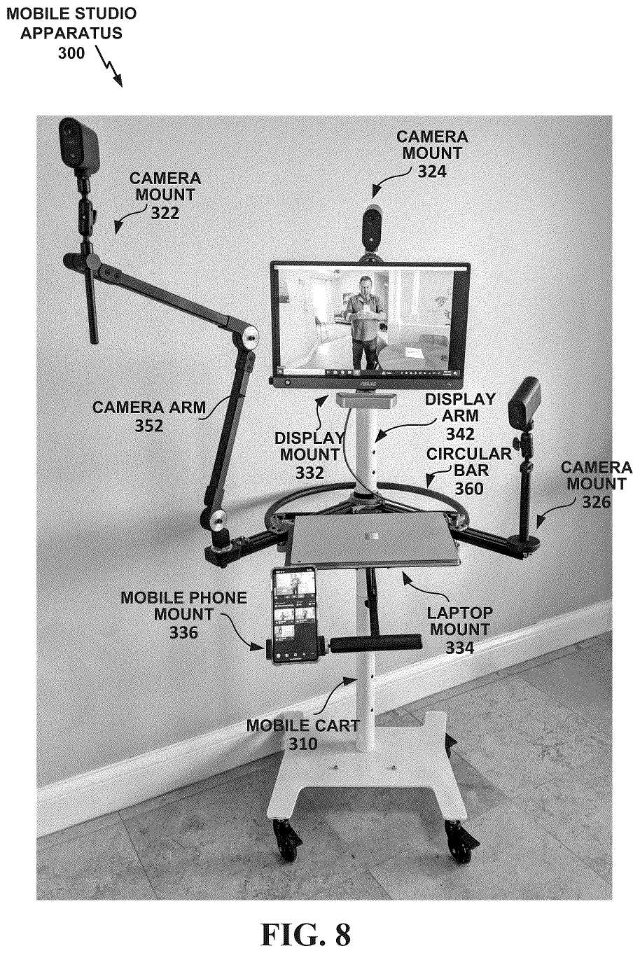

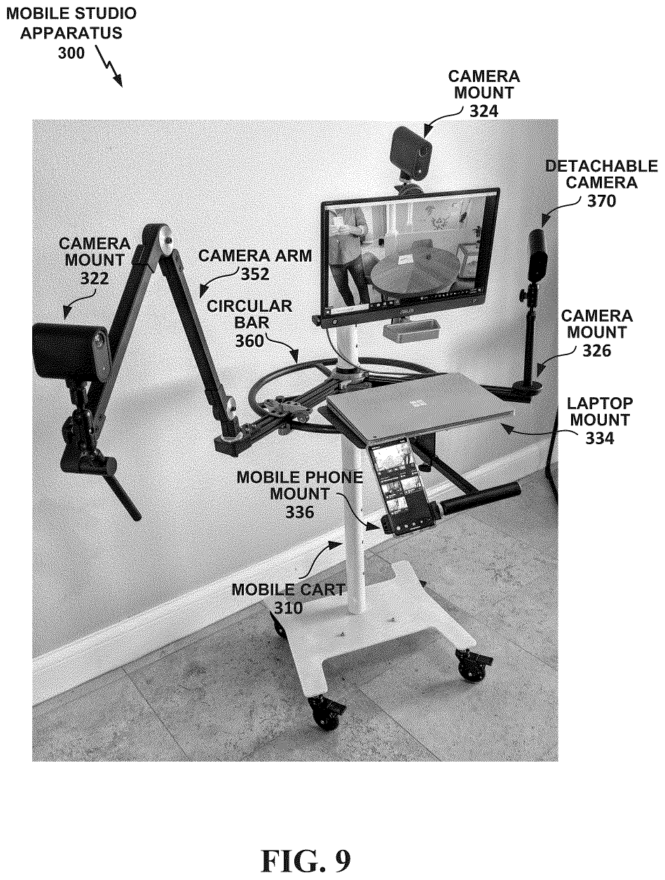

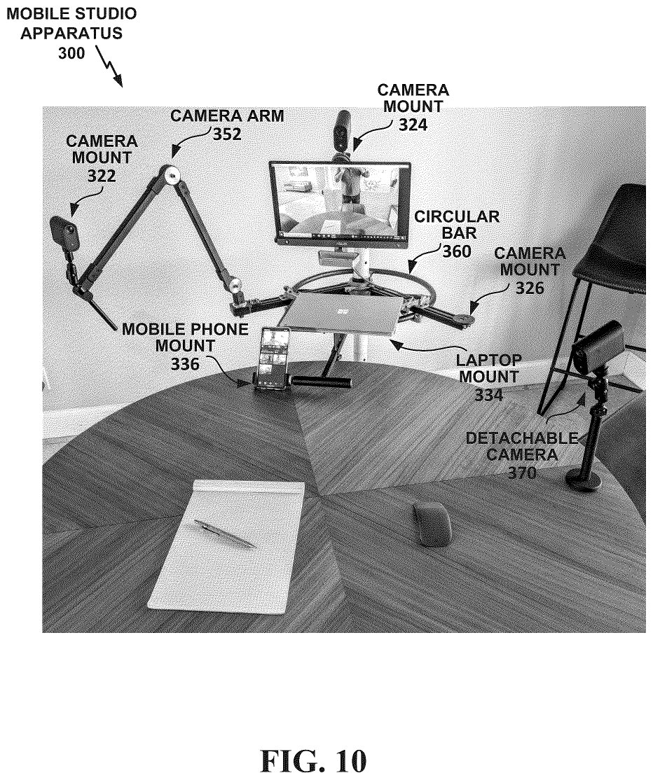

Turning now to FIGS. 3-10, various photos of an exemplary mobile studio apparatus are provided in accordance with aspects of the subject specification. For instance, FIGS. 3-4 are photos respectively illustrating a first and second view of an exemplary mobile studio apparatus 300 in accordance with an aspect of the subject specification. FIGS. 5-6 are photos respectively illustrating a rear view of an exemplary mobile studio apparatus 300 where the display arm 342 is in an unbent position and a bent position in accordance with an aspect of the subject specification. FIGS. 7-8 are photos respectively illustrating an exemplary mobile studio apparatus 300 where the display arm 342 is in an extended position and an unextended position in accordance with an aspect of the subject specification. FIGS. 9-10 are photos respectively illustrating an exemplary mobile studio apparatus 300 where a detachable camera 370 is attached and detached in accordance with an aspect of the subject specification.

As illustrated, mobile studio apparatus 300 may comprise a mobile cart 310 equipped with various types of device mounts, wherein such device mounts may be configured to attach to any of various types of devices. For example, some device mounts may be configured to attach to production-related devices (e.g., cameras, microphones, lights, etc.), such as camera mounts 322, 324, and 326. Some device mounts, however, may be configured to attach to user interface-related devices (e.g., a display, laptop computer, mobile phone, etc.), such as display mount 332, laptop mount 334, and mobile phone mount 336.

To facilitate adjusting the positioning and/or orientation of devices mounted on mobile cart 310, device mounts may be further coupled to pivot points, extendible/bendable arms, etc. For instance, display mount 332 may be coupled to a display arm 342, wherein display arm 342 may be configured to bend (e.g., as shown in FIGS. 5-6) and/or extend (e.g., as shown in FIGS. 7-8). Similarly, camera mounts may be coupled to extendible/bendable arms, such as the coupling of camera mount 322 to camera arm 352, as shown. Mobile cart 310 may also comprise a circular bar 360 configured to attach to any of the aforementioned device mounts (e.g., to facilitate a 360 degree horizontal/vertical positioning/orientation of devices).

Various exemplary use cases for mobile studio apparatus 300 are contemplated and listed below.

Aspect 1: A cart or stand with wheels (e.g., mobile cart 310) that provides a wireless platform for mounting multiple quick-release cameras 360° around the cart/stand.

Aspect 2: A cart or stand with wheels (e.g., mobile cart 310) that provides a wireless platform for mounting a display, cameras, microphones and lights on an articulating lockable arm to facilitate camera, microphone, lights and display positioning for optimal viewing and presentation ability.

Aspect 3: A cart or stand with wheels (e.g., mobile cart 310) that provides a wireless platform for mounting a camera on an articulating lockable arm to facilitate 360° horizontal camera positioning and 180° vertical camera positioning for optimal video capture and presentation.

Aspect 4: A cart or stand with wheels (e.g., mobile cart 310) that provides a wireless platform for mounting a camera on multiple articulating lockable arms with a locking feature rotating around a center pivot to facilitate 360° horizontal camera positioning.

Aspect 5: A cart or stand with wheels (e.g., mobile cart 310) that provides a wireless platform for mounting a camera on and articulating lockable arm to facilitate 360° horizontal microphone positioning and 180° vertical microphone positioning for optimal audio capture and presentation.

Aspect 6: A cart or stand with wheels (e.g., mobile cart 310) that provides a wireless platform for mounted cameras with a quick-release feature so cameras can be deployed away from the cart/stand and positioned for optimal video capture and presentation.

Aspect 7: A cart or stand with wheels (e.g., mobile cart 310) and multiple cameras that can be controlled by a wireless mobile device, wireless tablet, or minicomputer/laptop to facilitate camera switching, video recording and wireless video communication. A wireless mobile device or tablet could be secured to a presenter's arm or body, for example, to facilitate a hands-free presentation. The mobile device or tablet could also be controlled by voice recognition and voice commands.

Aspect 8: A cart or stand with wheels (e.g., mobile cart 310) that provides a wireless platform for mounting multiple quick-release cameras 360° around the cart with a mounted battery and central charging point to power multiple devices.

Aspect 9: A cart or stand with wheels (e.g., mobile cart 310) that provides a wireless platform for mounting multiple quick-release cameras 360° around the cart with a mount for a laptop computer.

Aspect 10: A cart or stand with wheels (e.g., mobile cart 310) that provides a wireless platform for mounting a display on an articulating arm that can be lowered to be viewed in a seated position and raised to be viewed in a standing position.

Aspect 11: A cart or stand with wheels (e.g., mobile cart 310) that provides a wireless platform for mounting a display, cameras, microphones, and lights and further includes a handle projecting laterally to facilitate moving the cart/stand by the operator for optimal positioning.

Aspect 12: A cart or stand with wheels (e.g., mobile cart 310) that provides a wireless platform for mounting a display, cameras, microphones, lights, and a platform for mounting a laptop or minicomputer for recording or hosting video presentations.

Aspect 13: A cart or stand with wheels (e.g., mobile cart 310) that provides a wireless platform for mounting a display, cameras, microphones, and lights, with the display facing the operator and displaying a script or teleprompter to facilitate spoken presentations.

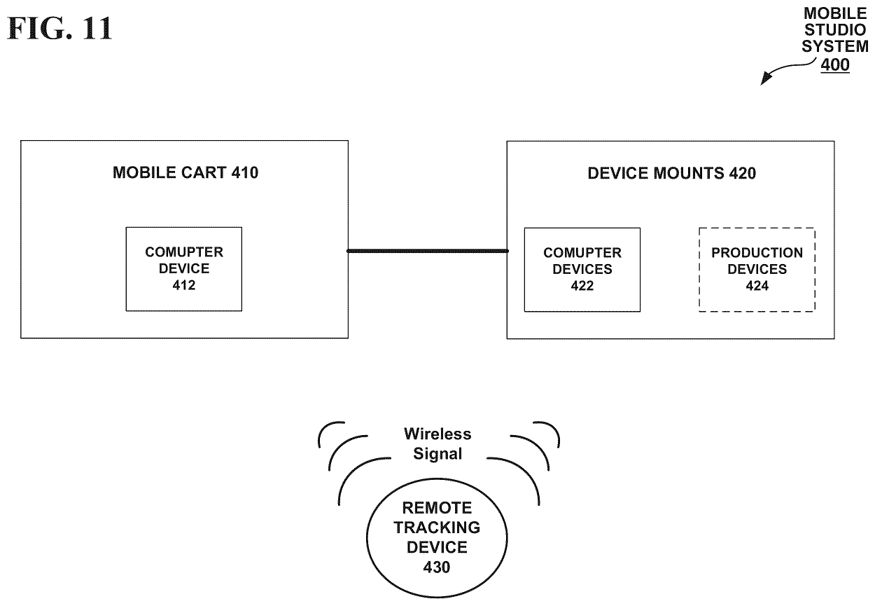

Referring next to FIG. 11, a block diagram of an exemplary mobile studio system that facilitates implementing aspects disclosed herein is provided. As illustrated, mobile studio system 400 includes mobile cart 410, device mounts 420, and remote tracking device 430. Here, it should be appreciated that mobile cart 410 is substantially similar to mobile cart 110 illustrated in FIGS. 1-2 and mobile cart 310 illustrated in FIGS. 3-10. It should be further appreciated that device mounts 420 and production devices 424 are substantially similar to the various device mounts and production devices illustrated in FIGS. 1-10.

In a particular aspect disclosed herein, remote tracking device 430 is communicatively coupled to mobile cart 410 and device mounts 420. During use, it is contemplated that a wireless signal transmitted by remote tracking device 430 is detectable by mobile cart 410 (e.g., via computer device 412) and device mounts 420 (e.g., via computer device 422). In a particular example, it is contemplated that remote tracking device 430 is physically coupled to a subject and configured to facilitate a physical tracking of the subject by mobile cart 410 (e.g., via computer device 412) and device mounts 420 (e.g., via computer device 422). For instance, a physical tracking of remote tracking device 430 by mobile cart 410 may comprise following a path of the subject (e.g., as the subject is walking around, mobile cart 410 follows via logic facilitated by computer device 412), whereas a physical tracking of remote tracking device 430 by device mounts 420 may comprise adjusting an orientation of device mounts 420 towards the subject (e.g., as the subject is walking around, device mounts 420 orient attached cameras toward the subject via logic facilitated by computer device 422).

Various exemplary use cases for mobile studio system 400 are contemplated and listed below.

Aspect 1: Multiple remote tracking devices 430 on a single subject respectively coupled to various device mounts 420. For instance, within a golf training context, a first remote tracking device 430 may be coupled to the subject's head and tracked by a camera on a first device mount 420, and a second remote tracking device 430 may be coupled to the subject's torso and tracked by a camera on a second device mount 420.

Aspect 2: Multiple remote tracking devices 430 on multiple subjects respectively coupled to various device mounts 420. For instance, within an interview context, a first remote tracking device 430 may be coupled to the interviewer and tracked by a camera on a first device mount 420, and a second remote tracking device 430 may be coupled to the interviewee and tracked by a camera on a second device mount 420.

Aspect 3: Multiple mobile carts 410 for multiple subjects. For instance, to facilitate video production/streaming where multiple subjects are not proximate to each other.

Aspect 4: Facial recognition to facilitate the following of a subject by mobile cart 410 and/or to orient a device mount 420 toward the subject.

Aspect 5: Utilizing a mobile device (e.g., a smartphone) as remote tracking device 430.

Aspect 6: Allowing a remote collaborator to control the tracking of a subject via mobile cart 410 and/or device mounts 420 (e.g., via remote collaborator devices 140).

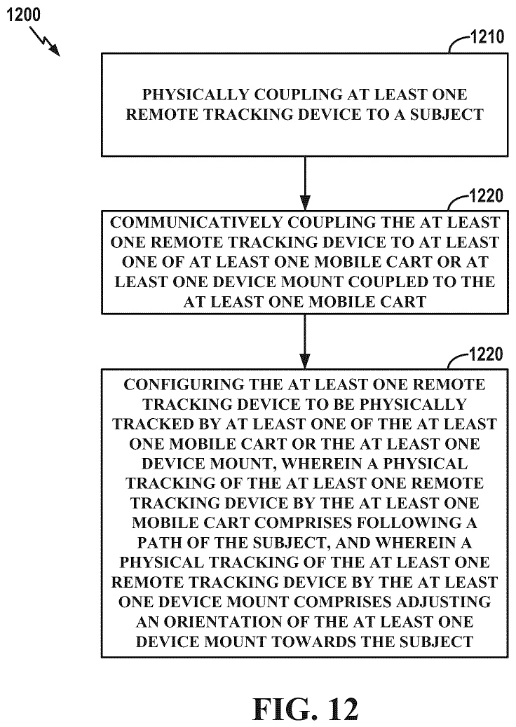

FIG. 12 is a flow diagram of an exemplary methodology that facilitates aspects disclosed herein;

Referring next to FIG. 12, a flow diagram illustrating an exemplary method that facilitates aspects disclosed herein is provided. As illustrated, process 1200 includes a series of acts that may be performed by a mobile studio system (e.g., mobile studio system 400) according to an aspect of the subject specification, wherein the series of acts may include any of the plurality of acts described with respect to FIGS. 1-11. For instance, process 1200 may be implemented by employing a processor to execute computer executable instructions stored on a computer readable storage medium to implement the series of acts. In another embodiment, a computer-readable storage medium comprising code for causing at least one computer to implement the acts of process 1200 is contemplated.

As illustrated, process 1200 may begin at act 1210 with physically coupling at least one remote tracking device to a subject, then proceeding to act 1220 by communicatively coupling the at least one remote tracking device to at least one of at least one mobile cart or at least one device mount coupled to the at least one mobile cart. At act 1230, process 1200 then concludes with configuring the at least one remote tracking device to be physically tracked by at least one of the at least one mobile cart or the at least one device mount, wherein a physical tracking of the at least one remote tracking device by the at least one mobile cart comprises following a path of the subject, and wherein a physical tracking of the at least one remote tracking device by the at least one device mount comprises adjusting an orientation of the at least one device mount towards the subject.

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

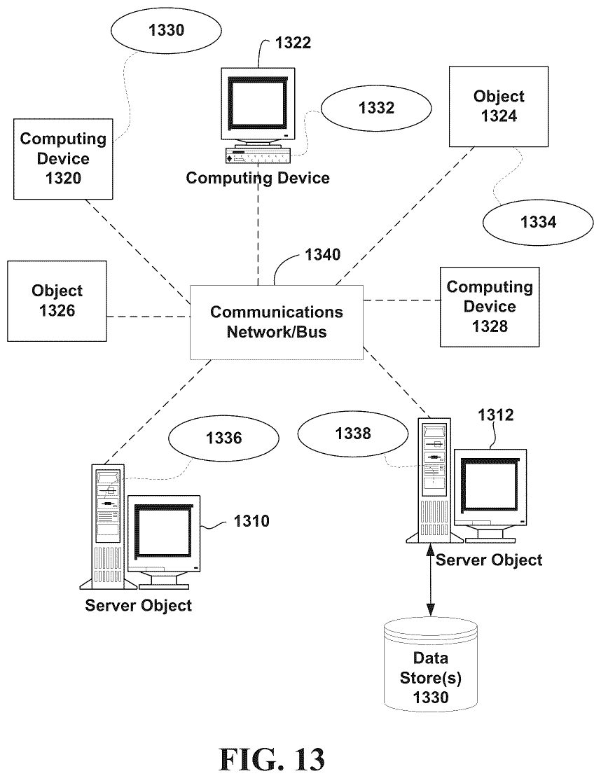

FIG. 13 provides a non-limiting schematic diagram of an exemplary networked or distributed computing environment. The distributed computing environment comprises computing objects or devices 1310, 1312, etc. and computing objects or devices 1320, 1322, 1324, 1326, 1328, etc., which may include programs, methods, data stores, programmable logic, etc., as represented by applications 1330, 1332, 1334, 1336, 1338. It can be appreciated that computing objects or devices 1310, 1312, etc. and computing objects or devices 1320, 1322, 1324, 1326, 1328, etc. may comprise different devices, such as PDAs (personal digital assistants), audio/video devices, mobile phones, MP3 players, laptops, etc.

Each computing object or device 1310, 1312, etc. and computing objects or devices 1320, 1322, 1324, 1326, 1328, etc. can communicate with one or more other computing objects or devices 1310, 1312, etc. and computing objects or devices 1320, 1322, 1324, 1326, 1328, etc. by way of the communications network 1340, either directly or indirectly. Even though illustrated as a single element in FIG. 13, network 1340 may comprise other computing objects and computing devices that provide services to the system of FIG. 13, and/or may represent multiple interconnected networks, which are not shown. Each computing object or device 1310, 1312, etc. or 1320, 1322, 1324, 1326, 1328, etc. can also contain an application, such as applications 1330, 1332, 1334, 1336, 1338, that might make use of an API (application programming interface), or other object, software, firmware and/or hardware, suitable for communication with or implementation of various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 13, as a non-limiting example, computing objects or devices 1320, 1322, 1324, 1326, 1328, etc. can be thought of as clients and computing objects or devices 1310, 1312, etc. can be thought of as servers where computing objects or devices 1310, 1312, etc. provide data services, such as receiving data from computing objects or devices 1320, 1322, 1324, 1326, 1328, etc., storing of data, processing of data, transmitting data to computing objects or devices 1320, 1322, 1324, 1326, 1328, etc., although any computer can be considered a client, a server, or both, depending on the circumstances. Any of these computing devices may be processing data, or requesting services or tasks that may implicate various embodiments and related techniques as described herein.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 1340 is the Internet, for example, the computing objects or devices 1310, 1312, etc. can be Web servers with which the computing objects or devices 1320, 1322, 1324, 1326, 1328, etc. communicate via any of a number of known protocols, such as HTTP. As mentioned, computing objects or devices 1310, 1312, etc. may also serve as computing objects or devices 1320, 1322, 1324, 1326, 1328, etc., or vice versa, as may be characteristic of a distributed computing environment.

### Exemplary Computing Device

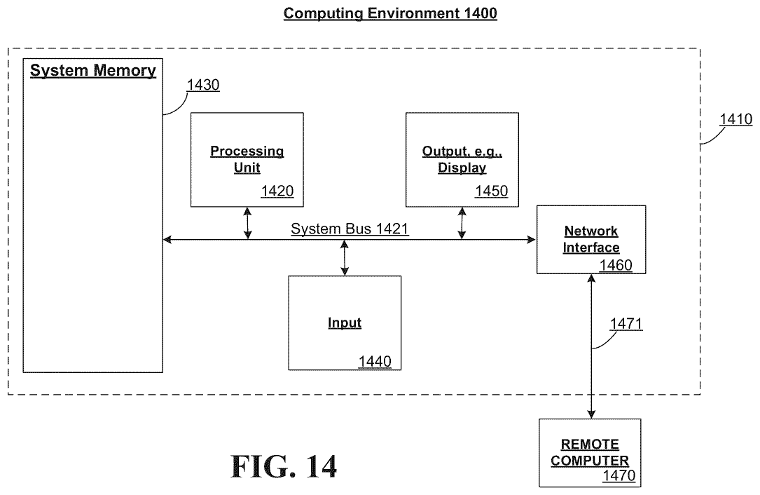

As mentioned, several of the aforementioned embodiments apply to any device wherein it may be desirable to utilize a computing device according to the aspects disclosed herein. It is understood, therefore, that handheld, portable and other computing devices and computing objects of all kinds are contemplated for use in connection with the various embodiments described herein. Accordingly, the below general purpose remote computer described below in FIG. 14 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 14 thus illustrates an example of a suitable computing system environment 1400 in which one or more of the embodiments may be implemented, although as made clear above, the computing system environment 1400 is only one example of a suitable computing environment and is not intended to suggest any limitation as to the scope of use or functionality of any of the embodiments. The computing environment 1400 is not to be interpreted as having any dependency or requirement relating to any one or combination of components illustrated in the exemplary operating environment 1400.

With reference to FIG. 14, an exemplary remote device for implementing one or more embodiments herein can include a general purpose computing device in the form of a handheld computer 1410. Components of handheld computer 1410 may include, but are not limited to, a processing unit 1420, a system memory 1430, and a system bus 1421 that couples various system components including the system memory to the processing unit 1420.

Computer 1410 typically includes a variety of computer readable media and can be any available media that can be accessed by computer 1410. The system memory 1430 may include computer storage media in the form of volatile and/or nonvolatile memory such as read only memory (ROM) and/or random access memory (RAM). By way of example, and not limitation, memory 1430 may also include an operating system, application programs, other program modules, and program data.

A user may enter commands and information into the computer 1410 through input devices 1440 A monitor or other type of display device is also connected to the system bus 1421 via an interface, such as output interface 1450. In addition to a monitor, computers may also include other peripheral output devices such as speakers and a printer, which may be connected through output interface 1450.

The computer 1410 may operate in a networked or distributed environment using logical connections to one or more other remote computers, such as remote computer 1470. The remote computer 1470 may be a personal computer, a server, a router, a network PC, a peer device or other common network node, or any other remote media consumption or transmission device, and may include any or all of the elements described above relative to the computer 1410. The logical connections depicted in FIG. 14 include a network 1471, such local area network (LAN) or a wide area network (WAN), but may also include other networks/buses. Such networking environments are commonplace in homes, offices, enterprise-wide computer networks, intranets and the Internet.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components coupled to other components rather than included within parent components (hierarchical). Additionally, it is noted that one or more components may be combined into a single component providing aggregate functionality or divided into several separate sub-components, and any one or more middle layers may be provided to couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the various figures. While for purposes of simplicity of explanation, the methodologies are described as a series of steps, it is to be understood and appreciated that the disclosed subject matter is not limited by the order of the steps, as some steps may occur in different orders and/or concurrently with other steps from what is described herein. Moreover, not all disclosed steps may be required to implement the methodologies described hereinafter.

While the various embodiments have been described in connection with the exemplary embodiments of the various figures, it is to be understood that other similar embodiments may be used or modifications and additions may be made to the described embodiment for performing the same function without deviating there from. Therefore, the present invention should not be limited to any single embodiment.

What is claimed is:

1. A mobile studio apparatus comprising:
a mobile cart;
at least one device mount coupled to the mobile cart, wherein the at least one device mount is configured to attach to a device, and wherein the at least one device mount is further configured to adjust an orientation of the device; and
a user interface communicatively coupled to devices configured to attach to the at least one device mount, wherein the user interface is configured to facilitate a video production or video collaboration via the devices configured to attach to the at least one device mount.

2. The mobile studio apparatus of claim 1, wherein the at least one device mount is configured to attach to a camera.

3. The mobile studio apparatus of claim 1, wherein the at least one device mount is configured to attach to a microphone.

4. The mobile studio apparatus of claim 1, wherein the at least one device mount is configured to attach to a light.

5. The mobile studio apparatus of claim 1, wherein the at least one device mount is a display mount configured to attach to a display unit, and wherein the display unit is configured to facilitate the video production or the video collaboration.

6. The mobile studio apparatus of claim 1, wherein the at least one device mount is configured to attach to a mobile phone.

7. The mobile studio apparatus of claim 1, wherein the at least one device mount is configured to attach to a laptop computer.

8. The mobile studio apparatus of claim 1, wherein the at least one device mount comprises a quick-release mechanism configured to facilitate readily attaching and detaching a device.

9. The mobile studio apparatus of claim 1, wherein the at least one device mount is coupled to the mobile cart via an adjustable arm.

10. The mobile studio apparatus of claim 1, wherein the mobile cart is configured to automatically follow a subject.

11. The mobile studio apparatus of claim 1, wherein the at least one device mount is configured to automatically orient the device toward a subject.

12. The mobile studio apparatus of claim 1, wherein the user interface is configured to receive voice commands to facilitate the video production or the video collaboration.

13. The mobile studio apparatus of claim 1, further comprising a charging apparatus coupled to the mobile cart, wherein the charging apparatus includes a battery and at least one charging point.

14. The mobile studio apparatus of claim 5, wherein the display mount is coupled to the mobile cart via an adjustable display arm.

15. The mobile studio apparatus of claim 14, wherein the adjustable display arm is extendable to facilitate height adjustments of the display unit.

16. The mobile studio apparatus of claim 14, wherein the adjustable display arm is bendable to facilitate height adjustments of the display unit.

17. The mobile studio apparatus of claim 1, further comprising a handle projecting laterally from the mobile cart to facilitate moving the moving the mobile cart.

18. The mobile studio apparatus of claim 5, wherein the user interface is configured to display a script or teleprompter on the display unit.

19. A mobile studio system comprising:
at least one mobile cart;
at least one device mount coupled to the at least one mobile cart, wherein the at least one device mount is configured to attach to a device, and wherein the at least one device mount is further configured to adjust an orientation of the device; and
at least one remote tracking device communicatively coupled to at least one of the at least one mobile cart or the at least one device mount, wherein the at least one remote tracking device is physically coupled to a subject and configured to facilitate a physical tracking of the subject by at least one of the at least one mobile cart or the at least one device mount.

20. A method comprising:
physically coupling at least one remote tracking device to a subject;
communicatively coupling the at least one remote tracking device to at least one of at least one mobile cart or at least one device mount coupled to the at least one mobile cart;
configuring the at least one remote tracking device to be physically tracked by at least one of the at least one mobile cart or the at least one device mount, wherein a physical tracking of the at least one remote tracking device by the at least one mobile cart comprises following a path of the subject, and wherein a physical tracking of the at least one remote tracking device by the at least one device mount comprises adjusting an orientation of the at least one device mount towards the subject.
